(19) United States
(12) Patent Application Publication
(10) Pub. No.: US 2010/0201613 A1
(43) Pub. Date: Aug. 12, 2010

(54) ILLUMINATING DEVICE AND DISPLAY DEVICE PROVIDED WITH THE SAME

(75) Inventor: Kentaro Kamada, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/670,705

(22) PCT Filed: Jul. 22, 2008
(86) PCT No.: PCT/JP2008/063130

§ 371 Date: Jan. 26, 2010

(30) Foreign Application Priority Data
Jul. 27, 2007 (JP) 2007-196093

(51) Int. Cl. G09G 3/36; F21V 7/04

(52) U.S. Cl. 345/102; 362/613

(57) ABSTRACT

An illuminating device in which luminance unevenness caused by a lamp holder of a tubular light source is reduced is provided as a large-area, thin illuminating device formed as a surface-emitting light source by an edge light method, and a thin, large-screen display device with low power consumption that is able to obtain a display image quality that is not a problem on a practical level is provided, by using the illuminating device as a backlight of a display element that displays an image by controlling transmission of light. The illuminating device includes a tabular light guide including a light emitting surface that is preferably substantially rectangular, tubular light sources provided respectively opposite two opposing lateral surfaces of the light guide, and at least one pair of lamp holders respectively holding the tubular light sources at intermediate portions of two opposing lateral surfaces of the light guide, and the lamp holders in the pair are disposed so as to be displaced from each other in a tube axis direction of the tubular light sources.

### BACKGROUND OF THE INVENTION

1. Field of the Invention

The present invention relates to a so-called edge-light surface-emitting illuminating device that causes light from a tubular light source to be incident from a lateral surface of a light guide and irradiates this incident light from a light-emitting surface, and more particularly to a thin, large-area illuminating device capable of irradiating uniform light, and to a display device that uses light radiated from the illuminating device as light to be transmitted through a display element.

2. Description of the Related Art

In recent years, liquid crystal display devices having features such as low power consumption and being thin and lightweight have become widely used as liquid crystal display devices for televisions. A liquid crystal panel constituting a display element of a liquid crystal display device is a so-called non-emissive display element that does not emit light itself. Accordingly, an illuminating device called a backlight is normally provided at a rear surface of the liquid crystal panel, and image display is performed by controlling the transmission of light from this backlight with the liquid crystals.

Here, as for the backlight of a liquid crystal display device, a surface-emitting illuminating device having uniform luminance and color over an entire surface of an image display area of the liquid crystal panel is desired, and two methods, namely, a direct light method and an edge light method, are known as methods for realizing such a surface-emitting backlight.

The direct light method involves disposing, normally, a plurality of fluorescent tubes serving as backlight light sources side-by-side at a rear surface of the liquid crystal panel, and using light irradiated from the fluorescent tubes as a surface-emitting light source whose luminance is made uniform by mediating a diffuser plate, a lens sheet or the like. On the other hand, with the edge light method (also called a side light method), the backlight is composed of a light-guiding plate whose shape corresponds to the image display area of the liquid crystal panel, and a fluorescent tube constituting a primary light source provided opposite a lateral surface of this light-guiding plate, and involves using light from the fluorescent tube that is incident from the lateral surface of the light-guiding plate as a surface-emitting light source by repeatedly reflecting and propagating this light within the light-guiding plate, and ultimately emitting the light on the liquid crystal panel side.

FIG. 8 is an exploded perspective view showing a schematic configuration of a liquid crystal display device provided with a direct-light backlight. As shown in FIG. 8, with a direct-light backlight 51, a plurality of fluorescent tubes 52, which are cold-cathode tubes or hot-cathode tubes, are disposed in parallel within a frame body 54. The fluorescent tubes 52 are normally held by sockets 53 at both ends thereof (only one end is visible in FIG. 8), but in the case of a large-scale liquid crystal display device, the fluorescent tubes 52 are also sometimes held by lamp holders (not shown) provided at intermediate portions. A reflective plate 55 is provided at the rear surface side of the fluorescent tubes 52, that is, the opposite side to a liquid crystal panel 58, and an improvement in luminescence efficiency is achieved by causing light radiated from the fluorescent tubes 52 toward the rear surface side to be reflected forward to form the radiated light from the backlight. A diffuser plate 56 and a lens sheet 57 are provided at a front surface of the fluorescent tubes 52, eliminating light and dark striped lamp image unevenness produced because of the fluorescent tubes 52 being disposed at prescribed intervals, and improving the directionality of light that is incident on the liquid crystal panel 58.

An image display area 59 is formed in a central portion of the liquid crystal panel 58 that excludes a peripheral portion in which extraction electrodes and driving circuits are formed, and the transmissivity of the liquid crystal layer is changed to perform image display by adjusting the voltage applied to embedded electrodes (not shown). In order to achieve an optical shutter function of the liquid crystal panel 58, a pair of polarizing plates 60 are disposed at a front surface side (user side) and a rear surface side (backlight side) of the liquid crystal panel, so that the directions of polarization of the polarizing plates differ by 90 degrees.

Such a direct-light backlight is often used in a liquid crystal display device for large-scale stationary televisions, display monitors or the like, taking advantage of the feature whereby irradiated light is amply obtained despite the somewhat high power consumption (see JP H11-2813A).

On the other hand, an edge-light backlight is used in liquid crystal display devices for mobile devices such as notebook computers and mobile terminals and in relatively compact liquid crystal display devices, given the characteristics of enabling low power consumption because of being able to decrease the number of fluorescent tubes used as light sources, and being able to reduce the depth of the backlight unit (see JP 2005-128363A).

However, recently, the transmissivity of liquid crystal panels has tended to improve, as technological development relating to liquid crystal display devices advances. Meanwhile, it has also become possible to irradiate light from a primary light source incident from a lateral surface efficiently and uniformly onto a liquid crystal panel, given advances in the technological development of light-guiding plates used in edge-light backlights. Considering the recent growing interest in ecological technologies and the strong need for thinner large-scale image display devices in this context, it can be sufficiently foreseen that, in the near future, edge-light backlights will also be employed in stationary large-scale liquid crystal display devices such as those that have conventionally employed direct-light backlights.

However, in order to irradiate the entire image display area of a liquid crystal panel using an edge-light backlight with a uniform amount of light, the light-emitting surface of the light-guiding plate used in the backlight needs to be the same shape but slightly larger than the image display area of the liquid crystal panel. Also, in order to sufficiently obtain the luminescence of the fluorescent tubes that is incident from the lateral surfaces of the light-guiding plate, preferably the fluorescent tubes oppose the light-guiding plate along the entire length of the lateral surfaces thereof. Since the image display area of a liquid crystal display device for televisions most commonly used for liquid crystal display devices is a wide screen with an aspect ratio of 16:9, fluorescent tubes compatible with such a wide screen will need to be more than 800 mm in length even when used in the backlight for a 37 inch liquid crystal display device, for example.

Holding such a long fluorescent tube with only the socket portions at both ends as is conventional is not preferable in terms of keeping the fluorescent tube straight without bending under its own weight, and also from the point of view of preventing the fluorescent tube from hitting the adjacent light-guiding plate and being damaged, in the case where a vibration is applied to the liquid crystal display device. One or more lamp holders for holding the fluorescent tube thus need to be provided at intermediate portions of the lateral surfaces of the light-guiding plate.

In this way, in the case where an edge-light backlight, which has conventionally been mainly applied to compact liquid crystal panels, is used in a liquid crystal display device for large-screen televisions, it is newly necessary to hold the fluorescent tubes using lamp holders that were not conventionally required, but a phenomenon occurs whereby the luminescence of the fluorescent tubes held by the lamp holders decreases at those portions. The cause of this decrease in luminance is due in part to the aspect of shape whereby the lamp holders themselves block the luminescence of the fluorescent tubes, but is caused mainly by the tube surface temperature of the fluorescent tubes decreasing at portions contacting the lamp holders because of heat being transferred to a chassis portion of the backlight unit via the lamp holders. That is, because luminescence efficiency drops when the tube surface temperature of the fluorescent tubes decreases at the portions contacting the lamp holders, the luminance of those portions decreases. This problem of the tube surface temperature decreasing due to heat being transferred via the lamp holders cannot be completely prevented no matter how much the shape of the lamp holders is devised, given that contact between the fluorescent tubes and the lamp holders is unavoidable.

Then, there is a problem that occurs when the luminance of a fluorescent tube decreases at the portion contacting a lamp holder, whereby a decreased luminance area is produced in which the luminance on the light-emitting surface of the light-guiding plate decreases below the surrounding area, at least in proximity to that lamp holder portion. There is a possibility of being able to alleviate the actual occurrence of this decreased luminance area to a level that is not a problem on a practical level, by devising the distribution of light-scattering substance within the light-guiding plate or the reflective structure of the rear surface of the light-guiding plate, but when the decreased luminance areas of the light-emitting surface of the light-guiding plate line up in a linear fashion, the luminance distributions of the decreased luminance portions and the surrounding portions may be perceived by a user as a large streaky luminance difference.

### SUMMARY OF THE INVENTION

In consideration of the above problems, preferred embodiments of the present invention provide an illuminating device in which luminance unevenness caused by a lamp holder of a tubular light source is reduced, as a large-area, thin illuminating device formed as a surface-emitting light source by an edge-light method, and a thin, large-screen display device with low power consumption that is able to obtain a display image quality that is not a problem on a practical level, by using the illuminating device as a backlight of a display element that displays an image by controlling transmission of light.

An illuminating device according to a preferred embodiment of the present invention includes a tabular light guide including a light-emitting surface that is preferably substantially rectangular, a tubular light source provided respectively opposite two opposing lateral surfaces of the light guide, and at least one pair of lamp holders respectively holding the tubular light source at intermediate portions of the two opposing lateral surfaces of the light guide, and the lamp holders in the pair are disposed so as to be displaced from each other in a tube axis direction of the tubular light source.

Also, a display device according to a preferred embodiment of the present invention includes a display element that displays an image by controlling transmission of light, and an illuminating device that illuminates light to be transmitted through the display element. The illuminating device includes a tabular light guide including a light-emitting surface that is preferably substantially rectangular, a tubular light source provided respectively opposite two opposing lateral surfaces of the light guide, and at least one pair of lamp holders respectively holding the tubular light source at intermediate portions of the two opposing lateral surfaces of the light guide, and the lamp holders in the pair are disposed so as to be displaced from each other in a tube axis direction of the tubular light source.

According to a preferred embodiment of the present invention, an illuminating device in which the luminance uniformity of radiated light from a light-emitting surface is enhanced can be obtained as a large-area, thin edge-light illuminating device. Also, a thin, large-screen display device with low power consumption in which luminance unevenness on an image display surface is reduced to a level that a user is not able to perceive can be realized, by using the illuminating device according to a preferred embodiment of the present invention as a backlight of a display element that displays an image by controlling transmission of light.

Other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view showing a schematic configuration of a liquid crystal display device according to a preferred embodiment of the present invention.

FIG. 2 is a main portion cross-sectional view showing a structure of a backlight unit of the liquid crystal display device according to a preferred embodiment of the present invention.

FIG. 3 shows a planar configuration of a backlight unit according to a first preferred embodiment of the present invention.

FIG. 4 shows a planar configuration of a comparative example of the backlight unit.

FIG. 5 shows a planar configuration of an application example of the backlight unit according to the first preferred embodiment of the present invention.

FIG. 6 shows a planar configuration of a backlight unit according to a second preferred embodiment of the present invention.

FIG. 7 shows a planar configuration of a backlight unit according to a third preferred embodiment of the present invention.

FIG. 8 is an exploded perspective view showing a schematic configuration of a conventional liquid crystal display device that uses a direct-light backlight.

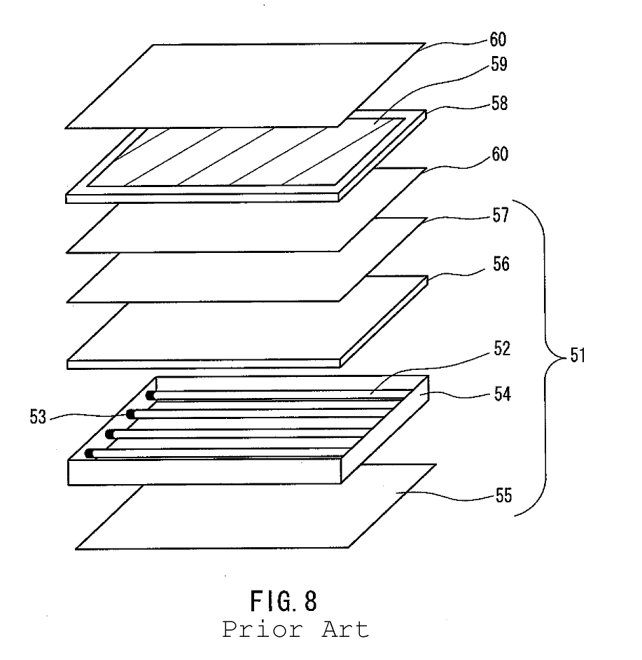

### DETAILED DESCRIPTION OF THE PREFERRED EMBODIMENTS

An illuminating device according to preferred embodiments of the present invention includes a tabular light guide including a light-emitting surface that is preferably substantially rectangular, a tubular light source provided respectively opposite two opposing lateral surfaces of the light guide, and at least one pair of lamp holders respectively holding the tubular light source at intermediate portions of the two opposing lateral surfaces of the light guide, and the lamp holders in the pair are disposed so as to be displaced from each other in a tube axis direction of the tubular light source.

According to this configuration, even if the light-emission luminance of the tubular light source decreases at the portions held by the lamp holders, and decreased luminance areas in which the luminance of the light-emitting surface of the light guide in proximity to the portions occur, it is possible to effectively prevent these decreased luminance area portions from becoming linearly linked on the light-emitting surface and being perceived by a user.

Also, with the above configuration, preferably at least the lamp holders in a pair respectively holding the tubular light source provided respectively opposite two lateral surfaces of longer sides of the light guide, at intermediate portions of the two lateral surfaces of the longer sides of the light guide, are disposed so as to be displaced from each other in the tube axis direction of the tubular light source.

This makes it possible to effectively prevent luminance unevenness on the light-emitting surface from being perceived by a user, even if the tubular light source disposed on the two longer sides of the light guide, where the interval between opposing sides is narrow, is supported by lamp holders.

Further, more preferably two or more pairs of the lamp holders respectively holding the tubular light source are provided at intermediate portions of the two lateral surfaces of the longer sides of the light guide, and the lamp holders are disposed so as to be displaced from each other in the tube axis direction of the tubular light source.

This configuration makes it possible to realize an illuminating device in which luminance unevenness is not readily perceived by a user, while securely holding the long tubular light source that is used in order to handle a wide light-emitting surface.

Also, preferably the tubular light source is provided respectively opposite all four lateral surfaces of the light guide, and the lamp holders respectively holding the tubular light source at intermediate portions of the lateral surfaces of the light guide are disposed so as to be displaced from each other in the tube axis direction of the tubular light source, with respect to the lamp holders provided on the opposing lateral surfaces of the light guide.

In the case where the tubular light source is disposed at all four lateral surfaces of the light guide, it is possible to effectively prevent the decreased luminance areas produced as a result of the lamp holders respectively provided on opposing lateral surfaces becoming linearly linked on the light-emitting surface, and being perceived as a whole as cross-shaped or lattice-shaped luminance unevenness by a user.

Also, preferably the lamp holders have one of polycarbonate and silicone rubber as a main component.

Preferably an illuminating device according to a preferred embodiment of the present invention is used as a backlight of a display element that displays an image by controlling transmission of light.

This is because an illuminating device according to a preferred embodiment of the present invention, which is a thin, large-area surface-emitting light source that enables power consumption to be reduced, is particularly suitable as a backlight of such a display element.

Also, a display device according to a preferred embodiment of the present invention includes a display element that displays an image by controlling transmission of light, and an illuminating device that illuminates light to be transmitted through the display element, the illuminating device having a tabular light guide including a light-emitting surface that is preferably substantially rectangular, a tubular light source provided respectively opposite two opposing lateral surfaces of the light guide, and at least one pair of lamp holders respectively holding the tubular light source at intermediate portions of the two opposing lateral surfaces of the light guide, with the lamp holders in the pair being disposed so as to be displaced from each other in a tube axis direction of the tubular light source.

According to this configuration, it is possible to obtain a display device that is able to perform excellent image display, by reducing the luminance unevenness of the backlight, which causes the image quality of a display image to decrease, to a level that is not a problem on a practical level.

Also, a display device can be obtained that is able to perform more favorable image display, by employing a preferred embodiment of the above illuminating device according to the present invention in carrying out an image display device of the present invention.

Hereinafter, preferred embodiments of an illuminating device of the present invention and a display device provided with the same will be described with reference to the drawings. Note that, hereinafter, the display device according to various preferred embodiments of the present invention will be described, illustrating a device that uses an illuminating device according to a preferred embodiment of the present invention as a backlight thereof, as a liquid crystal display device for televisions that is provided with a transmissive-type liquid crystal display element. As for the display element of the display device according to a preferred embodiment of the present invention, a semi-transmissive-type liquid crystal display element can be used, for example. Also, the display device according to a preferred embodiment of the present invention is not intended to be limited to a liquid crystal display device for televisions, and can be used in information display monitors in public organizations such as a train station or an art gallery, computer monitors requiring large screens, or the like. Further, an illuminating device according to a preferred embodiment of the present invention can also be used in all large-area, thin illuminating devices in general, such as a panel illuminating device embedded in a ceiling, wall or the like or a surface illuminating device that illuminates a show window display, rather than only being used as the backlight of an image display device.

### First Preferred Embodiment

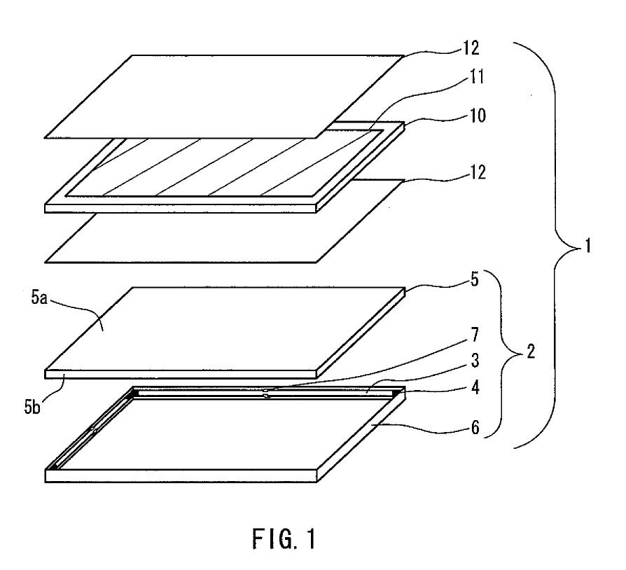

FIG. 1 is an exploded perspective view showing a schematic configuration of a display device according to a first preferred embodiment of the present invention. As shown in FIG. 1, a liquid crystal display device 1 according to a preferred embodiment of the present invention includes a liquid crystal panel 10 which is a display element and a backlight unit 2 which is an illuminating device that radiates transmission light necessary for performing image display in this liquid crystal panel 10.

The backlight unit 2 includes a floored frame body 6, a plurality (e.g., four) of fluorescent tubes 3 (only two are visible in FIG. 1) which are tubular light sources respectively fixed to an inner surface of the four side walls of this frame body 6, and a light-guiding plate 5 which is light guide provided in a position such that lateral surfaces 5b thereof oppose these fluorescent tubes 3.

The fluorescent tubes 3 have a fluorescent substance that radiates white light applied inside a glass tube with an inner diameter of about 3 mm to about 4 mm and an outer diameter of about 5 mm to about 6 mm, and electrodes for creating a discharge are sealed in both ends thereof. The fluorescent tubes 3 used as the backlight of a liquid crystal panel are normally cold cathode tubes, but it is not intended to exclude hot cathode tubes in the application of the present invention. Also, the lengths of the fluorescent tubes 3 correspond to the lengths of the lateral surfaces 5b of the light-guiding plate 5 that the fluorescent tubes 3 are arranged opposite to the lengths of the sides of a light-emitting surface 5a of the light-guiding plate 5.

Both end portions of the fluorescent tubes 3 are plugged into sockets 4 (only one side is visible in FIG. 1) and supplied with a voltage necessary for luminescence, and both end portions of the fluorescent tubes 3 are held by these sockets 4. With the backlight unit 2 of the liquid crystal display device 1 according to the present preferred embodiment, central portions of the fluorescent tubes 3 in a tube axis direction, that is, intermediate portions of the adjacent lateral surfaces 5b of the longer or shorter sides of the light-guiding plate 5 are held by lamp holders 7. It is thus possible to make the fluorescent tubes 3 precisely oppose the lateral surfaces 5b of the light-guiding plate 5 along the entire length thereof, and to ensure that the luminescence of the fluorescent tubes 3 is incident inside the light-guiding plate 5. Also, the fluorescent tubes 3 are held such that the central portions thereof in the tube axis direction are not damaged by hitting the lateral surfaces 5b of the light-guiding plate 5, due to vibrations that occur when the liquid crystal display device 1 is impacted from the outside. Note that, while not illustrated in FIG. 1, normally, reflectors for guiding the light from the fluorescent tubes 3 to the light-guiding plate 5 are provided around the fluorescent tubes 3. These reflectors and the lamp holders 7 will be discussed in detail later.

The light-guiding plate 5 is a tabular portion formed using transparent or translucent resin such as polymethyl methacrylate resin. The light-emitting surface 5a which corresponds to the surface thereof is preferably rectangular and corresponding in shape and size to an image display area 11 of the liquid crystal panel 10. The light-emitting surface 5a of the light-guiding plate 5 is formed slightly larger than the image display area 11 of the liquid crystal panel 10, in order to provide irradiated light to the entire image display area 11. Also, the rectangular shape referred to here is in effect a rectangle corresponding to the image display area 11 of the liquid crystal panel 10 as a whole, without taking into consideration the rounded shape of the corner portions or the small protrusions, cutouts and the like that are provided for handling and holding/fixing the light-guiding plate 5.

The thickness of the light-guiding plate 5 is appropriately set in correspondence with the outer diameter of the fluorescent tubes 3 that are used, with the thickness of the light-guiding plate 5 being about 8 mm, for example, in the present preferred embodiment. If the light-guiding plate 5 is too thin, luminescence from the fluorescent tubes 3 cannot be sufficiently introduced into the light-guiding plate 5. Conversely, if the light-guiding plate 5 is too thick, the amount of light emitted to the outside of the light-guiding plate 5, when reflecting and propagating light incident from the lateral surfaces 5b therein, increases during this process due to the angle of incidence to the light-emitting surface 5a of the light-guiding plate 5 increasing, which is not preferable in terms of ensuring the uniformity of luminance serving as a surface-emitting light source.

Also, the light-guiding plate 5 according to the present preferred embodiment is not intended to exclude various devices being carried out for causing light incident from the lateral surfaces 5b of the light-guiding plate 5 to be emitted from the light-emitting surface 5a with a uniform luminance distribution, similarly to a conventional light-guiding plate. As for these various devices, methods are known that involve adjusting the density distribution of the light scattering substance enclosed within the light-guiding plate 5, increasing the thickness of the actual light-guiding plate 5 at the lateral surface 5b portion where the fluorescent tubes 3 are disposed and decreasing the thickness at the central portion, providing sheets or coating for reflecting light propagating inside at the rear surface on the opposite side to the light-emitting surface 5a of the light-guiding plate 5, or providing a fine black coat to prevent the luminance of the light-emitting surface 5a becoming too high in proximity to where the light from the fluorescent tubes 3 is incident.

The liquid crystal panel 10 is a transmissive-type active matrix panel in which a plurality of pixels disposed in a horizontal and vertical matrix form the image display area 11. By controlling the voltage applied to an electrode (not shown) of each pixel, the orientation of the liquid crystal molecules enclosed in the panel is changed to control the transmitted amount of light and display an image. Terminals, driving circuits and the like for applying voltages to the electrodes are arranged in the area around the image display area 11. A pair of polarizing plates 12 for achieving a shutter effect on transmission light by changing the orientation of the liquid crystal molecules are disposed one on either side of the liquid crystal panel 10. Normally, the two polarizing plates 12 are disposed such that the polarizing direction thereof differs by 90 degrees.

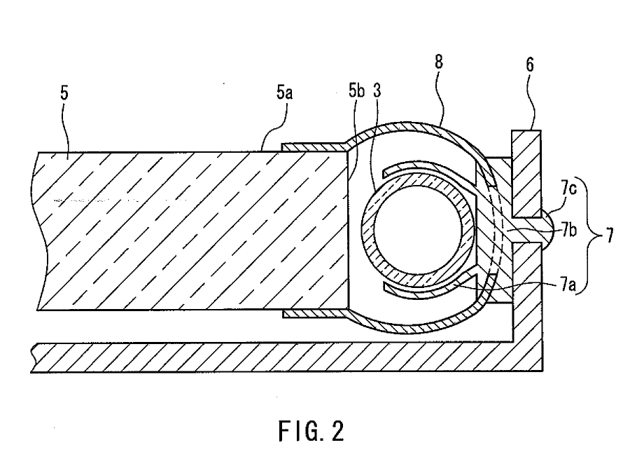

FIG. 2 is an enlarged cross-sectional view showing a lamp holder 7 portion of the backlight unit 2 used in the display device according to the present preferred embodiment. As shown in FIG. 2, the lamp holder 7 preferably includes a leading pair of arm portions 7a, a base portion 7b to which the arm portions 7a are connected, and a fixed portion 7c protruding from the base portion 7b. The pair of arm portions 7a of the lamp holders 7 hold the fluorescent tube 3 by restraining the fluorescent tube 3 from the top and the bottom. These arm portions 7a need to be long enough to hold and fix the fluorescent tube 3, but are configured so as to not cover the portion that faces the lateral surface 5b of the light-guiding plate 5 that the fluorescent tube 3 opposes and block the luminescence directly incident on the light-guiding plate 5 from the fluorescent tube 3. The base portion 7b of the lamp holder 7 contacts the lateral surface of the frame body 6 constituting the backlight unit 2, and is adhered to the frame body 6 by a portion thereof forming the fixed portion 7c which passes through the frame body 6.

As for the lamp holder 7, a portion that itself has high light transmissivity and does not physically block luminescence from the fluorescent tube 3, or a member with high surface reflectance with respect to light from the fluorescent tube 3 is preferable. Also, a substance with low thermal conductivity is preferable, so as to minimize the decrease in temperature of the fluorescent tube 3 at portions contacting to the lamp holder 7. Further, in the case where the illuminating device is actually manufactured as the backlight unit 2, the arm portions 7a require a certain degree of flexibility and enough holding ability to prevent the fitted fluorescent tube 3 from dropping out, since the fluorescent tube 3 is fitted into these arm portions 7a in a state where the lamp holder 7 is fixed.

Thus, as for the lamp holder 7, a member whose main component is impact-resistant, non-deformable polycarbonate having a transparency equivalent to glass, or a member whose main component is silicone rubber with respect to which a desired hardness is obtained by selecting the type of hardener and that can be used as a glossy white material is preferable. Also, a member to which a necessary additive has been appropriately added with these substances as a main component can be used, and as for the other members, a flexible transparent acrylic resin can be used. Note that, here, a “main component” implies using polycarbonate or silicone rubber as a basic material, and that contamination by impurities including unavoidable substances is not excluded.

A reflector 13 is obtained by performing glossy white coating on a metal or resin surface, and improves light utilization of the fluorescent tubes 3, by reflecting light that is not traveling directly to the light-guiding plate 5 out of the luminescence from the fluorescent tubes 3 and causing the light to be incident on the lateral surfaces 5b of the light-guiding plate 5. A leading portion of the reflector 13 is adhered to the light-emitting surface 5a of the light-guiding plate 5 and the rear surface on the opposite side thereof, and the other portion thereof is formed in a shape that encloses the fluorescent tube 3 with a prescribed interval therebetween, so as to envelope the fluorescent tube 3. The area between the fluorescent tube 3 and the sidewall portion of the frame body 6 is basically all covered with the reflector 13, but the portion where the lamp holder 7 shown in FIG. 2 is provided cannot be covered with the reflector 13 since the lamp holder 7 needs to be adhered to the frame body 6. Thus, with the portion where the lamp holder 7 is formed, the reflector 13 is embedded into the base portion 7b of the lamp holder 7. This allows an effect to be obtained whereby, with the lamp holder 7 portion, the efficiency with which light from the fluorescent tube 3 is reflected by the reflector 13 decreases very slightly but the reflector 13 can be held and fixed at the portion where the lamp holder 7 is formed.

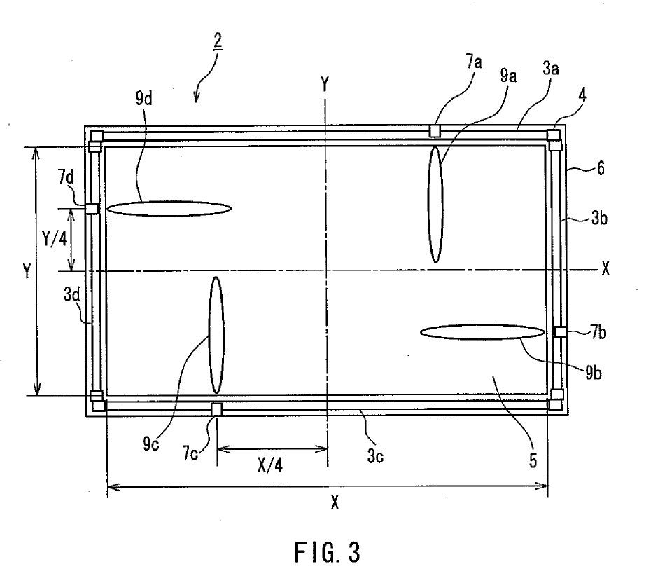

Next, a planar disposition of the lamp holders 7 will be described using FIG. 3. FIG. 3 is a planar view of the backlight unit 2 according to the present preferred embodiment as seen from the light-emitting surface 5a side of the light-guiding plate 5. Note that the reflectors 13 are also not illustrated in FIG. 3, in order to clearly show the positions of the lamp holders 7. Also, normally, a flanged structure for mounting the liquid crystal panel on the backlight unit 2 extends from a leading portion of the frame body 6 on the liquid crystal panel side to the periphery of the light-emitting surface 5a of the light-guiding plate 5, but illustration is omitted in the description of preferred embodiments of the present invention. Further, in the diagrams showing a state of the backlight unit 2 in planar view from FIG. 3 to FIG. 7, an X-axis parallel with the horizontal direction of the display device and a Y-axis parallel with the vertical direction are shown passing through the center of the light-emitting surface 5a of the light-guiding plate 5, for convenience of description.

As shown in FIG. 3, in the backlight unit 2 of the display unit in the present preferred embodiment, for example, four fluorescent tubes 3a to 3d are provided opposite all four lateral surfaces of the light-guiding plate 5. The respective fluorescent tubes 3a to 3d have lengths corresponding to the lengths of the lateral surfaces of the light-guiding plate 5 that each fluorescent tube is opposed to along an entire length thereof, and are disposed such that substantive luminescence output portions other than the electrode forming portions at both ends oppose substantially an entire length of the lateral surfaces of the light-guiding plate 5, so as to gain amounts of light to be incident on the light-guiding plate. Note that both ends of the four fluorescent tubes 3a to 3d are plugged into sockets 4, and a voltage is applied to the fluorescent tubes 3a to 3d from these sockets 4, together with both ends being held by the sockets 4.

Also, the four fluorescent tubes 3a to 3d are held by lamp holders 7a to 7d respectively provided at intermediate portions of the lateral surfaces of the light-guiding plate 5 that the fluorescent tubes respectively oppose, that is, one each at intermediate portions of the sides of the light-emitting surface 5a. These lamp holders 7a to 7d are all disposed at positions removed, in a clockwise direction, by a distance equivalent to ¼th of the length of the respective sides of the light-emitting surface 5a from the center of each side of the light-emitting surface 5a, that is, from the position at which the X-axis or the Y-axis shown in FIG. 3 intersects each side of the light-emitting surface 5a.

Specifically, the lamp holder 7c provided in correspondence with the lower side of the light-emitting surface 5a is provided in a position that is displaced to the left side by a distance of “X/4”, which is ¼th of the length X of the longer side, from the position of the Y-axis, which is the center of the longer side of the light-emitting surface 5a. The lamp holder 7a formed on the upper longer side of the light-emitting surface 5a is provided in a position that is displaced to the right side by the same distance “X/4” from the Y-axis. Also, the lamp holders 7b and 7d provided in correspondence with the shorter sides of the light-emitting surface 5a are provided in positions that are displaced to the upper side in the case of 7d and to the lower side in the case of 7b from the positions at which the X-axis intersects the shorter sides, by a distance of “Y/4”, which is ¼th of the length Y of the shorter sides.

As a result, the pair of the lamp holders 7a and 7c that hold the fluorescent tubes 3a and 3c provided respectively opposite the lateral surfaces of the longer sides of the light-guiding plate 5, at intermediate portions of the two lateral surfaces of the longer sides of the light-guiding plate, are disposed so as to be displaced from each other in the tube axis direction of the fluorescent tubes 3a and 3c. Also, similarly, the pair of the lamp holders 7b and 7d that hold the fluorescent tubes 3b and 3d provided respectively opposite the lateral surfaces of the shorter sides of the light-guiding plate 5, at intermediate portions of the two lateral surfaces of the shorter sides of the light-guiding plate 5, are disposed so as to be displaced from each other in the tube axis direction of the fluorescent tubes 3b and 3d.

With the illuminating device or the display device according to a preferred embodiment of the present invention, by thus disposing pairs of lamp holders 7 respectively holding fluorescent tubes 3 provided respectively opposite two opposing lateral surfaces of the light-guiding plate 5, at intermediate portions of the two lateral surfaces, so as to be displaced from each other in the tube axis direction of the fluorescent tubes 3, it is possible to prevent decreased luminance areas 9 on the light-guiding plate 5 produced by the lamp holders 7 from being formed in a linear fashion and make it unlikely that these areas will be perceived as luminance unevenness of the display image by a user viewing the display device.

These actions and effects of preferred embodiments of the present invention will be further described in detail.

As described above, when the fluorescent tubes 3 are held at intermediate portions by the lamp holders 7, rather than only by the sockets 4 at both ends, heat from the fluorescent tubes 3 is transferred to the frame body 6 of the backlight unit 2 via the lamp holders 7, causing the tube surface temperature of the fluorescent tubes 3 at portions contacting the lamp holders 7 to decrease and luminescence efficiency to fall. Also, due to the lamp holders 7 themselves blocking the luminescence of the fluorescent tubes 3, and the reflective surface of the reflectors 13 differing from other portions as shown in FIG. 2 owing to the provision of the lamp holders 7, the incident amount of light on the light-guiding plate 5 from the fluorescent tubes 3 falls below that of other portions at the lamp holder 7 portions. For this reason, decreased luminance areas 9a to 9d such as illustrated are produced in correspondence to the respective lamp holders 7a to 7d in FIG. 3. Completely preventing the occurrence of these decreased luminance areas 9a to 9d is difficult on a practical level.

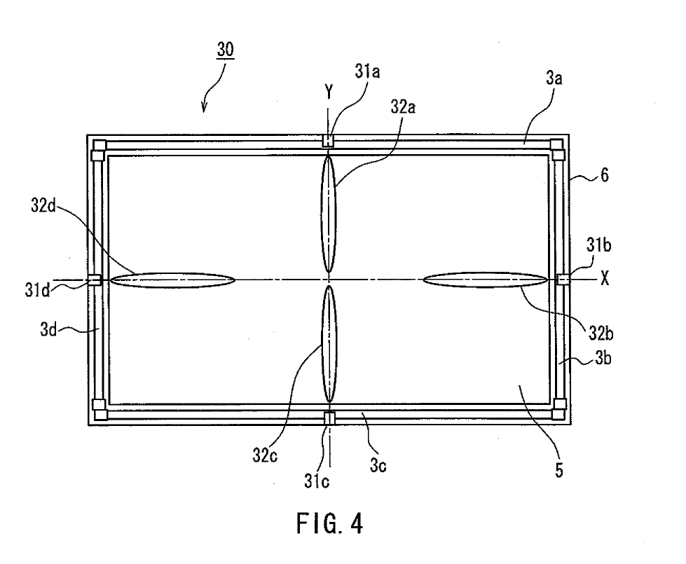

Here, a backlight unit 30 serving as a comparative example of the backlight unit 2 according to the present preferred embodiment shown in FIG. 3 is shown as FIG. 4. Note that FIG. 4, the same as FIG. 3, is a planar view as seen from the light-emitting surface 5a side of the light-guiding plate 5, and illustration of the reflectors 13 is omitted.

The backlight unit 30 serving as a comparative example shown as FIG. 4 also has four fluorescent tubes 3a to 3d disposed opposite all of the lateral surfaces of the light-guiding plate 5, and intermediate portions of the fluorescent tubes are held by the lamp holders 31a to 31d, the same as the backlight unit 2 of the display device according to the first preferred embodiment of the present invention shown in FIG. 3. However, the holding positions of the lamp holders 31a to 31d differ from the working example shown in FIG. 3 in that the X-axis and the Y-axis, which are central portions of all four sides of the light-emitting surface 5a, are formed at portions intersecting the sides of the light-emitting surface 5a. That is, in the comparative example shown in FIG. 4, the pair of lamp holders 31a and 31c provided in central portions of the two opposing longer sides of the light-emitting surface 5a are disposed in the same positions in the tube axis direction of the fluorescent tubes 3a and 3c. Also, the pair of lamp holders 31b and 31d provided in central portions of the two opposing shorter sides of the light-emitting surface 5a are disposed in the same positions in the tube axis direction of the fluorescent tubes 3b and 3d.

As in the comparative example shown in FIG. 4, in the case where lamp holders 31 holding the fluorescent tubes 3 disposed opposite two opposing lateral surfaces of the light-emitting surface 5a are formed in the same positions in the tube axis direction of the fluorescent tubes 3, decreased luminescence areas 32 produced by the respective lamp holders 31 are formed substantially linearly on the light-emitting surface 5a. Specifically, decreased luminescence areas 32a and 32c formed by lamp holders 31a and 31c for holding the fluorescent tubes 3a and 3c corresponding to the longer sides of the light-emitting surface 5a are both formed on the Y-axis of the light-emitting surface 5a and linked substantially linearly. Also, decreased luminescence areas 32b and 32d formed by lamp holders 31b and 31d for holding the fluorescent tubes 3b and 3d corresponding to the shorter sides of the light-emitting surface 5a are both formed on the X-axis of the light-emitting surface 5a and are substantially linear.

The possibility of the decreased luminescence areas 32 formed on the light-emitting surface 5a being perceived by the user can be lowered by reducing the degree of the decrease in luminance, but when the decreased luminescence areas 32 are linked linearly as shown in FIG. 4, the risk of the user being aware of these areas increases even with a decrease in brightness of the same extent. This is because, for a user viewing the entire image, decreased luminescence areas that are linearly linked are readily perceived by the human eye, since they form streaky dark patterns across the entire image.

In contrast, with the backlight unit 2 of the display device according to the present preferred embodiment shown in FIG. 3, since the decreased luminescence areas 9a and 9c produced on the light-emitting surface 5a by the pair of respectively opposing lamp holders 7a and 7c, and the decreased luminescence areas 9b and 9d produced on the light-emitting surface 5a by the pair of lamp holders 7b and 7d are produced so as to all be displaced from each other in the tube axis direction of the fluorescent tubes 3a to 3d, these decreased luminance areas 9a to 9d will not be linked linearly. Accordingly, even if the proportion of luminance decreases in the decreased luminance areas is the same, the proportion of this that the user perceives as streaky luminance unevenness in image display can be greatly decreased.

Note that in the present preferred embodiment, an example is shown in which not only the lamp holders 7a and 7c provided on the longer sides of the light-emitting surface 5a but also the lamp holders 7b and 7d provided on the shorter sides are disposed so as to be displaced from each other in the tube axis direction of the fluorescent tubes 3, but disposition of the lamp holders of an illuminating device according to the present invention is not necessary limited to this. As is also clear from FIG. 4, in the case where the size of the decreased luminescence areas 32 produced by a single lamp holder 31 are equal, the possibility of the decreased luminescence areas 32b and 32d produced by the lamp holders 31b and 31d provided on the shorter sides of the light-guiding plate 5, with respect to which the distance between the opposing sides of the light-emitting surface 5a is comparatively long, being perceived as a line of streaky luminance unevenness is much lower than the possibility of the decreased luminescence areas 32a and 32c produced by the lamp holders 31a and 31c provided on the longer sides being perceived as a line of streaky luminance unevenness. Accordingly, there may not be a problem on a practical level, even if the lamp holders 7b and 7d located at the lateral surfaces of the shorter sides of the light-guiding plate 5 are disposed in the same position in the tube axis direction of the fluorescent tubes 3b and 3d, the greater the ratio of the longer side to the shorter side of the light-emitting surface 5a, that is, the greater the aspect ratio of the image display area of the liquid crystal display device. The illuminating device of the present invention is not intended to exclude the case where only the positions of the lamp holders on the longer sides are displaced in this way, while the positions of the lamp holders on the shorter sides are not displaced.

Also, in the present preferred embodiment as described above, the case was described where the lamp holders 7 are disposed so as to each be displaced from the center of the longer sides and shorter sides of the light-emitting surface 5a by a distance of about ¼^{th}, for example, of the length of the respective sides. This is because holding the fluorescent tubes at positions that are each displaced by about ¼^{th}, for example, of the lengths of the longer sides and the shorter sides in this way is considered to be the most suitable position from both the point of view of preventing luminance unevenness caused by the lamp holders and the physical point of view of fixedly holding intermediate portions of long fluorescent tubes with lamp holders. With the illuminating device and the display device according to the present invention, the disposition positions of the lamp holders are, however, not intended to be limited to the above-described positions that are each displaced by about ¼th of the sides. For example, it has been confirmed that the effect of preventing luminance unevenness due to the lamp holders can be sufficiently achieved by displacing the lamp holders so that the distance of the disposition position of the lamp holders from the center of the sides is around ⅛th of the length of the sides.

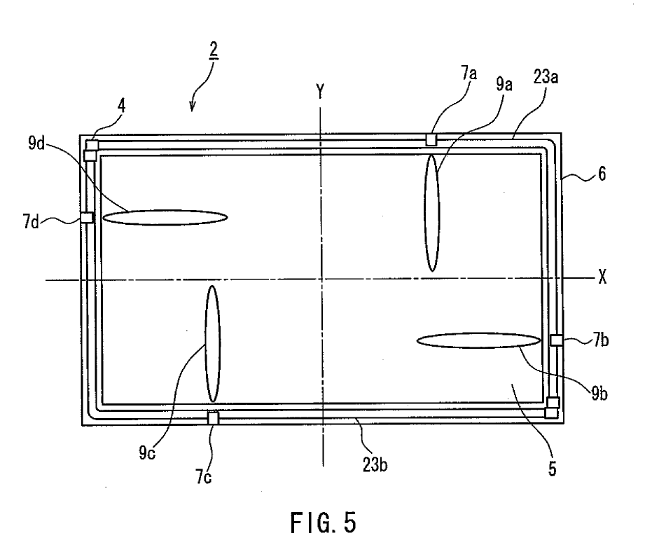

Next, an application example of the backlight unit 2 of the image display device 1 according to a preferred embodiment of the present invention will be shown using FIG. 5. FIG. 5, the same as FIG. 3, is a planar view of the backlight unit 2 as seen from the light-emitting surface 5a side of the light-guiding plate 5, and illustration of the reflectors 13 is omitted, similarly to FIG. 3.

With the application example shown in FIG. 5, the use of two fluorescent tubes 23a and 23b bent at 90 degrees at intermediate portions thereof, so as to oppose two adjacent lateral surfaces, as the fluorescent tubes provided opposite the four lateral surfaces of the light-guiding plate 5 differs from the configuration shown in FIG. 3 in which the four fluorescent tubes 3a to 3d corresponding to the sides were used. Note that since the lamp holders 7a to 7d holding the fluorescent tubes 23a and 23b at intermediate portions are disposed in exactly the same positions as the example shown in FIG. 3, the decreased luminance areas 9a to 9d produced by the four lamp holders also occur in the same positions as the example shown in FIG. 3. Accordingly, even with the application example shown in FIG. 5, a similar effect can be obtained whereby the possibility of the decreased luminance areas caused by the lamp holders linking linearly and being perceived by a user as a line of dark streaky luminance unevenness can be reduced.

Also, for similar reasons, the present invention is not intended to be limited to the case where the two fluorescent tubes 23a and 23b such as shown in FIG. 5 respectively oppose two adjacent lateral surfaces of the light-guiding plate 5, and even in a case such as where a single fluorescent tube has two bent portions and opposes three lateral surfaces of the light-guiding plates, and another single straight fluorescent tube opposes the remaining lateral surface, or a case such as where a single fluorescent tube formed so as to encircle the four lateral surfaces of the light-guiding plate 5 is used, a similar effect can be obtained by disposing the lamp holders as in the present preferred embodiment described above.

Note that while not illustrated in FIG. 5, holders that hold the fluorescent tubes 23a and 23b are provided at the bent portions of the two fluorescent tubes 23a and 23b arranged opposite to two adjacent sides of the light-emitting surface 5a of the light-guiding plates. However, since these bent portions of the fluorescent tubes 23a and 23b correspond to the corner portions of the light-guiding plate 5, there is little need to pay special attention to the amount of light that is incident on the light-guiding plate 5 from these bent portions, and the holders of these bent portions need only be designed with consideration given to the holders aptly supporting the lamp.

Also, with regard to the case of the application example shown in FIG. 5, by displacing only the positions of the lamp holders 7a and 7c provided on the longer sides of the light-guiding plate, with respect to which the decreased luminance areas 9a and 9c could easily become linearly linked, from each other in the tube axis direction of the fluorescent tubes 23a and 23b, a determinate effect can be obtained without displacing the position of the lamp holders 7b and 7d provided on the shorter sides of the light-guiding plate 5 in the tube axis direction of the fluorescent tubes 23a and 23b, as mentioned above.

### Second Preferred Embodiment

A display device according to a second preferred embodiment of the present invention will be described hereinafter. Note that since the display device according to this second preferred embodiment only differs from the display device described in the first preferred embodiment with respect to a backlight unit 2 thereof, description of the overall configuration of the display device will be omitted. Repetitive description regarding the constituent elements described in the first preferred embodiment will also be omitted.

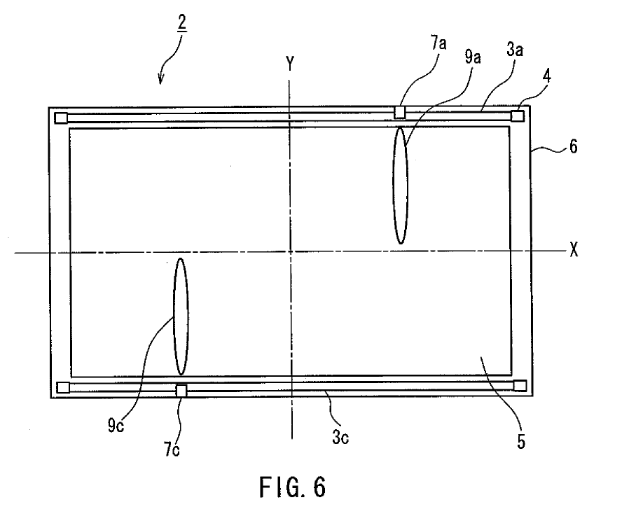

FIG. 6 shows a planar configuration of the backlight unit 2 of a liquid crystal display device 1 according to the second preferred embodiment of the present invention. As shown in FIG. 6, with the backlight unit 2 of the liquid crystal display device 1 according to the present preferred embodiment, two fluorescent tubes 3a and 3c that are only arranged so as to oppose the lateral surfaces of the longer sides of the light-guiding plate 5 constitute the fluorescent tubes 3 that are disposed on the periphery of a light-guiding plate 5 including a rectangular light-emitting surface 5a and form the light source of light radiated from the light-guiding plate 5. This aspect differs from the backlight unit 2 according to the first preferred embodiment shown in FIG. 3 that had the four fluorescent tubes 3a to 3d corresponding to all four sides.

A pair of lamp holders 7a and 7c that hold the two fluorescent tubes 3a and 3c at intermediate portions thereof are disposed at intermediate portions of the lateral surfaces of the longer sides of the light-guiding plate 5. The lamp holders 7a and 7c in the pair are both disposed, in a clockwise direction, in positions removed from the portions where the two longer sides of the light-emitting surface 5a and the Y-axis intersect, which is the central portion of the two longer sides of the light-emitting surface 5a, by a distance of about “X/4”, which is about ¼th of the length X of the longer sides of the light-emitting surface 5a. That is, the lamp holders are disposed so as to be displaced from each other in the tube axis direction of the fluorescent tubes 3a and 3c.

Thus, it is possible to prevent the decreased luminance areas 9a and 9c that appear on the light-emitting surface 5a of the light-guiding plate 5 due to the lamp holders 7a and 7c from linking linearly, and to effectively prevent a user viewing a display image from perceiving the decreased luminance areas 9 as a line of streaky luminescence unevenness, and feeling that the image display quality is low.

The image display area of a liquid crystal display device for televisions that is most commonly used as a display device according to the present invention has a 16:9 wide aspect ratio in order to be compatible with terrestrial digital broadcasting. Thus, the light-emitting surface 5a of the light-guiding plate 5 of the backlight unit 2 used as the backlight of the display device also has a wide shape of substantially 16:9, in correspondence with this display area.

Providing fluorescent tubes defining light sources so as to oppose the lateral surfaces of the longer sides of the light-guiding plate is both effective and necessary, in order to ensure that light emitted from such a wide light-guiding plate is uniform at the light-emitting surface thereof, but even if the fluorescent tubes forming light sources are provided opposite the lateral surfaces of the short sides, the emitted light thereof is propagated in the lateral direction of the light-guiding plate, making it quite difficult to obtain the uniformity of a surface light source. Thus, in the case where uniformity of the amount of radiated light over the entire light-emitting surface of the light-guiding plate is an important consideration, it is fully envisaged that it may instead be preferable not to dispose fluorescent tubes at the lateral surfaces of the short sides. This second preferred embodiment is intended to take into consideration such a situation.

### Third Preferred Embodiment

Next, a display device according to a third preferred embodiment of the present invention will be described hereinafter. Note that since the display device according to this third preferred embodiment only differs from the display devices described in the first preferred embodiment and the second preferred embodiment with respect to a backlight unit 2 thereof, description of the overall configuration of the display device will be omitted. Repetitive description regarding the constituent elements described in the first preferred embodiment will also be omitted.

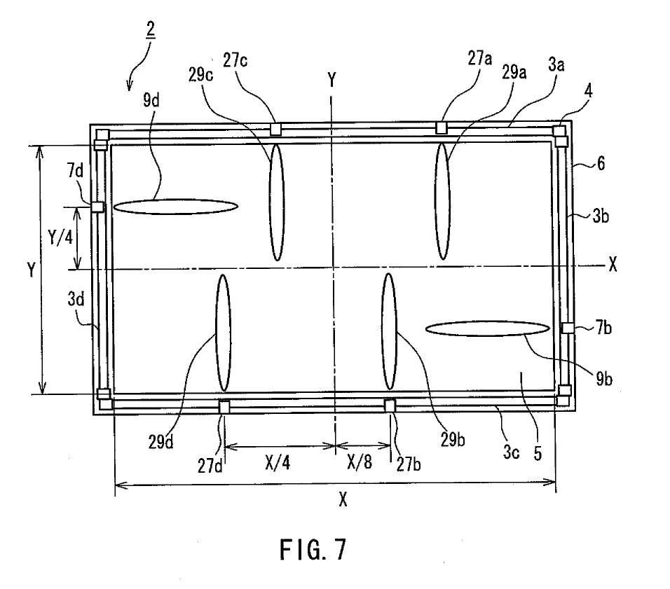

FIG. 7 shows a planar configuration of the backlight unit 2 of a liquid crystal display device 1 according to the third preferred embodiment of the present invention. As shown in FIG. 7, with the backlight unit 2 of the liquid crystal display device 1 according to the present preferred embodiment, the fact that two fluorescent tubes 3a and 3c disposed opposite the lateral surfaces of the longer sides of a light-guiding plate 5 including a rectangular light-emitting surface 5a are respectively held by two lamp holders 27a and 27c and two lamp holders 27b and 27d differs from the backlight unit 2 according to the first preferred embodiment shown in FIG. 3, in which the lamp holders 7a and 7c are provided one each for the fluorescent tubes 3a and 3c.

Specifically, the first lamp holder 27b holding the fluorescent tube 3c provided in correspondence with the lower side of the light-emitting surface 5a is disposed in a position displaced to the right side by a distance of about “X/8”, which is about ⅛th of the length X of the longer sides of the light-emitting surface 5a, from the intersection with the Y-axis, which is the center of the lower side of the light-emitting surface 5a, and the second lamp holder 27d holding the fluorescent tube 3c is disposed in a position displaced to the left side by a distance of about “X/4”, which is about ¼th of the length X of the longer sides of the light-emitting surface 5a, from the intersection with the Y-axis. Also, the lamp holder 27a holding the fluorescent tube 3a is disposed in a position displaced to the right side by a distance of about “X/4” from the position of the Y-axis, and the lamp holder 27c is disposed in a position displaced to the left side by a distance of about “X/8” from the position of the Y-axis.

As a result, with the backlight unit 2 of the image display device according to the present preferred embodiment, the fluorescent tubes 3a and 3c provided opposite the lateral surfaces of the longer sides of the light-guiding plate 5 are held by two pairs of lamp holders, namely, the lamp holders 27a and 27b and the lamp holders 27c and 27d, and these two pairs of the lamp holders 27a and 27b and 27c and 27d are disposed so as to all be displaced from each other in the tube axis direction of the fluorescent tubes 3a and 3c.

It is thereby possible to prevent the decreased luminance areas 29a and 29b of the light-emitting surface 5a produced due to the pair of lamp holders 27a and 27b and the decreased luminance areas 29c and 29d of the light-emitting surface 5a produced due to the other pair of lamp holders 27c and 27d from both lining up in a linear fashion. It is thus possible to effectively prevent decreased luminance areas that are lined up in a linear fashion from being perceived as a line of streaky luminance unevenness by a user viewing a display image on the display device.

Note that in the case of the present preferred embodiment shown in FIG. 7, the pair of lamp holders 7b and 7d provided at the fluorescent tubes 3b and 3d provided opposite the lateral surfaces of the shorter sides of the light-guiding plate 5 are also disposed so as to be displaced from each other by a distance of about “Y/4”, which is about ¼th of the length Y of the short sides of the light-emitting surface 5a in the tube axis direction of the fluorescent tubes 3b and 3d. Accordingly, it is also possible to prevent the decreased luminance areas 9b and 9d produced due to the lamp holders 7b and 7d linking linearly in the lateral direction of the display screen, and being perceived as a single lateral line of streaky luminance unevenness by a user viewing a display image. Thus, it is possible to effectively prevent the user from perceiving the luminance unevenness as grid-shaped luminance unevenness resulting from streaky luminance unevenness in the longitudinal and lateral directions joining into one.

As described above, in the case where a liquid crystal display device for televisions that is most commonly used as a display device according to a preferred embodiment of the present invention, the aspect ratio of a display image is 16:9, and the length of the longer sides thereof reaches approximately 1.8 times the length of the shorter sides. Accordingly, in order to hold fluorescent lamps that correspond in length to longer sides and shorter sides of a light-guiding plate differing in length in this way at substantially uniform intervals, the fluorescent tubes corresponding to the longer sides need to be held with two lamp holders. The present preferred embodiment takes into consideration such circumstances.

Note that in the present preferred embodiment, as described in the above first preferred embodiment, a prescribed effect may be obtained without necessarily disposing the lamp holders 7b to 7d, which hold the fluorescent tubes 3b and 3d opposing the lateral surfaces of the shorter sides of the light-guiding plate 5, so as to be displaced in the tube axis direction of the fluorescent tubes 3b and 3d.

Also, even in the case where fluorescent tubes are not opposed to the lateral surfaces of the shorter sides of the light-guiding plate, as shown in the second preferred embodiment, it is possible to effectively prevent the decreased luminance areas produced by the lamp holders from being perceived by a user as streaky luminance unevenness, by supporting a single fluorescent tube such as in the present preferred embodiment with two lamp holders and disposing these lamp holders so as to be displaced from each other in the tube axis direction of the fluorescent tubes, as lamp holders holding the fluorescent tubes opposing the lateral surfaces of the longer sides.

Of course, in the case where the fluorescent tubes disposed opposite the lateral surfaces of the longer sides of the light-guiding plate are each supported by three or more lamp holders, or in the case where the fluorescent tubes disposed opposite the lateral surfaces of the short sides of the light-guiding plate are each supported by two or more lamp holders, it is possible to effectively reduce luminance unevenness on the light-emitting surface of the light-guiding plate, by applying the one of the concepts and novel features of the present preferred embodiment, which is to dispose the positions of respectively opposing lamp holders so as to be displaced from each other in the tube axis direction of the fluorescent tubes.

Also, an example in which the formation positions of the lamp holders are disposed so as to be displaced in the clockwise direction by the same amount was shown as the preferred embodiments of the present invention, but the present invention is not intended to be limited to this. The lamp holders can be appropriately designed by, for example, displacing the lamp holders in the counterclockwise direction, differentiating the amount of shift between the lamp holders on the longer sides and the lamp holders on the shorter sides, or differentiating the amount of shift of all of the lamp holders, in a range in which the decreased luminance areas caused by the lamp holders are not formed linearly and perceived by a user as a line of streaky luminance unevenness.

Also, in the above preferred embodiments, examples were shown where there was preferably only one fluorescent tube disposed opposite the lateral surfaces of the light-guiding plate in the thickness direction of the light-guiding plate, but in order to improve the light-emission luminance from the fluorescent tubes that is incident from the lateral surfaces of the light-guiding plate, it is also conceivable to dispose two or three or more fluorescent tubes so as to be lined up in the thickness direction. In this case, by displacing the respective positions of the lamp holders of the fluorescent tubes from each other in the tube axis direction of the fluorescent tubes, it is possible to make uniform the luminescence brightness from the light-emitting surface of the light-guiding plate to a level that is not a problem on a practical level.

Preferred embodiments of the present invention are practically useful as an illuminating device serving as a thin, large-area, surface light source, and more particularly as an illuminating device suitable for use as a backlight for a transmissive-type display device, and as a display device in which this illuminating device is provided as a backlight.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-11. (canceled)

12. An illuminating device comprising:
a tabular light guide including a light-emitting surface that is preferably substantially rectangular;
a tubular light source provided respectively opposite two opposing lateral surfaces of the light guide; and
at least one pair of lamp holders respectively holding the tubular light source at intermediate portions of the two opposing lateral surfaces of the light guide; wherein
the lamp holders in the pair are disposed so as to be displaced from each other in a tube axis direction of the tubular light source.

13. The illuminating device according to claim 12, wherein at least the lamp holders in a pair respectively holding the tubular light source provided respectively opposite two lateral surfaces of longer sides of the light guide, at intermediate portions of the two lateral surfaces of the longer sides of the light guide, are disposed so as to be displaced from each other in the tube axis direction of the tubular light source.

14. The illuminating device according to claim 13, wherein at least two pairs of the lamp holders respectively holding the tubular light source are provided at intermediate portions of the two lateral surfaces of the longer sides of the light guide, and the lamp holders are disposed so as to be displaced from each other in the tube axis direction of the tubular light source.

15. The illuminating device according to claim 12, wherein the tubular light source is provided respectively opposite all four lateral surfaces of the light guide, and the lamp holders respectively holding the tubular light source at intermediate portions of the lateral surfaces of the light guide are disposed so as to be displaced from each other in the tube axis direction of the tubular light source, with respect to the lamp holders provided on the opposing lateral surfaces of the light guide.

16. The illuminating device according to claim 12, wherein the lamp holders include one of polycarbonate and silicone rubber as a main component.

17. The illuminating device according to claim 12, wherein the illuminating device is used as a backlight of a display element that displays an image by controlling transmission of light.

18. A display device comprising:
a display element arranged to display an image by controlling transmission of light; and
an illuminating device arranged to illuminates light to be transmitted through the display element, the illuminating device including:
a tabular light guide including a rectangular light-emitting surface;
a tubular light source provided respectively opposite two opposing lateral surfaces of the light guide; and
at least one pair of lamp holders respectively holding the tubular light source at intermediate portions of the two opposing lateral surfaces of the light guide; wherein
the lamp holders in the pair are disposed so as to be displaced from each other in a tube axis direction of the tubular light source.

19. The display device according to claim 18, wherein at least the lamp holders in a pair respectively holding the tubular light source provided respectively opposite two lateral surfaces of longer sides of the light guide, at intermediate portions of the two lateral surfaces of the longer sides of the light guide, are disposed so as to be displaced from each other in the tube axis direction of the tubular light source.

20. The display device according to claim 19, wherein at least two pairs of the lamp holders respectively holding the tubular light source are provided at intermediate portions of the two lateral surfaces of the longer sides of the light guide, and the lamp holders are disposed so as to be displaced from each other in the tube axis direction of the tubular light source.

21. The display device according to claim 18, wherein the tubular light source is provided respectively opposite all four lateral surfaces of the light guide, and the lamp holders respectively holding the tubular light source at intermediate portions of the lateral surfaces of the light guide are disposed so as to be displaced from each other in the tube axis direction of the tubular light source, with respect to the lamp holders provided on the opposing lateral surfaces of the light guide.

22. The display device according to claim 18, wherein the lamp holders include one of polycarbonate and silicone rubber as a main component.
